(19) United States
(12) Patent Application Publication
(10) Pub. No.: US 2004/0243676 A1
(43) Pub. Date: Dec. 2, 2004

(54) Message manager for tracking customer attributes

(76) Inventor: Mark H. Blankenship, Missouri City, TX (US)

Correspondence Address: ALTON W. PAYNE, Attorney, SUITE 200, 5001 BISSONNOT, BELLAIRE, TX, 77401, US

(21) Appl. No.: 10/444,721

(22) Filed: May 24, 2003

(51) Int. Cl. G06F 15/16

(52) U.S. Cl. 709/206; 709/207; 709/228

(57) ABSTRACT

The present invention relates to a message manager providing for implementing a message having the name of a prospect and a personalized message to that particular prospect within a message. The message manager provides for the following functions: maintenance, message library, edit message, create new message, subject library, edit subject, create new subject, logoff, executing a mail out, displays the user's name, select Microsite™ message for the recipients to visit, page name, preview, create subject or select subject from existing subjects, message library to select existing messages from drop down menu, create one time message or display selected message text, message replacement tags, link label, masks URL with “hot” text such as “click here,” customer search allows the user to select recipients by name, city, state, profile, or company name, select customers to send mail out to, check/uncheck all, include opt out message, submit sends message mail outs, and confirmation screen lists number of mail outs; successful and failed.

### FIELD OF THE INVENTION

The present invention relates generally to tracking potential purchaser attributes. Specifically, the present invention relates to a system designed to simultaneously carry out two fundamental functions: to determine who, when, what and where with respect to prospective customer attributes, and to inform the prospective customer of specific information needed to make informed decisions by tracking potential purchaser attributes.

### BACKGROUND OF THE INVENTION

The Internet contains a wealth of possible contacts and information to people in the marketing industry. The main problem is identifying means for gathering data on behavior for specifically identified users or user groups. Almost all businesses and consumers have access to the Internet and regularly use e-mail.

U.S. Pat. No. 6,167,435 given to Druckenmiller on Dec. 26, 2000 describes a system whereby interested users are given the opportunity to sign up for an e-mail list or single mail-out. The user then must verify that they are interested in the mail-out by clicking on a link in an email sent to the user to verify their interest. This is considered to be an example of a “double-op-in” system. This system is difficult gain a detailed amount of information about whether the user is reading any of the mail generated and sent to them past the initial interest.

Direct email marketing gives a marketer the ability to target individuals and send them correspondence. Although, normally the marketer does not receive feedback on whether the individual was even interested in that type of correspondence. Also, the marketer can not determine if the advertisement was opened, read, or acted upon unless the individual responds the email.

U.S Published Patent Application 2002/0032602 by Kenneth Lanzillo was published on Mar. 14, 2002. This Application discloses a refined means for direct mail marketing. The application describes a server containing a collection of individuals whom have filled out demographic surveys. The database can then be probed by marketers wanting to communications to a group of individuals with identified characteristics. The server then matches the query with potentially interested individuals and sends correspondence from the marketers. The marketers do not learn the email addresses of the members of the group they sent correspondence to provided protection for the database on individuals on the server.

A method for tracking behavior and interests while a user is on the Internet is also useful. Companies have tracked individual's behavior on the Internet by storing a packet of information on the user's hard drive and tracking where all the packet is observed on different web sites. This system is only effective all the web sites visited are clients of the same company providing the initial packet of information. These packets are commonly called “cookies” in the industry.

U.S. Patent Application 2002/0078191 by Lorenz was published on Jun. 20, 2002. The patent application discloses a system for tracking an individual's behavior across many different web resources across the Internet during a single web session. The Patent application describes the use of a gateway web server that is situated between an Internet user and the desired web resource. The gateway server tracks the behavior of the individual during their whole web session by recording the different sites the user visited and other identifiable characteristics.

The prior art provides for two existing technologies in the business development arena that have tried to solve the problems referenced herein. They are email marketing and website tracking. Email marketing tracks clicks from a flashy html page that is the body of an email. The primary focus is on up-selling and cross-selling. Website tracking fundamentally tracks website visitors without knowing “who” the visitor is or for example, the visitor's name, address, etc. There has never been a proven way to know who has read your marketing materials, when they read it or to electronically measure true interest.

What is needed is a seamless system for a person that desires to do marketing whereby they can link together and can have feedback tracking through direct mail marketing, email marketing, and website marketing. This system would be more efficient and would provide real-time statistics of user behavior and interest in targeted products and services.

To achieve such a system, there are five basic questions every sales and marketing professional needs to know about their prospects, customers and clients. The five basic questions are:

Who is reading the marketing materials?

When are they reading it?

What kinds of services are they interested in?

Where did they go to find out information about the products and services?

Why are they interested in the products and services?

Knowing the answers to these five basic questions provides the ability for marketing and sales organizations to efficiently streamline their respective efforts. The efforts can be streamlined by knowing:

Who to target?

What to say, ask, emphasize?

When to follow-up or provide more information?

Where to focus valuable time, resources and money?

Why a prospect needs your product or service?

It is, therefore, a feature of the present invention to provide a system which determines who is reading the marketing materials, when the marketing material is being read, what kinds of services are of interest, where did they go to find out information about the products and services, and why are they interested in the products and services?

A feature of the present invention is to provide a system to achieve better returns on your prospect and customer information assets.

Another feature of the present invention is to provide a system to amplify your exposure to enable sales to develop more business opportunities and drive revenue.

Another feature of the present invention is to provide a system to integrate sales and marketing organizations efforts for improved productivity.

Another feature of the present invention is to provide a system to accelerate the urgency of your customer acquisition efforts using existing resources to increase revenue.

Yet another feature of the invention is to provide a system to accelerate the focus of your customer acquisition efforts using existing resources to increase revenue.

Still another feature of the present invention is utilizing a system to accelerate your customer acquisition process.

Another feature of the present invention is to provide a system to know the needs and interests of your prospects and customers.

Yet another feature of the present invention is to provide a system to know where prospects and customers are in the sales cycle.

Still another feature of the present invention is to provide a system to increase a company's client base.

Yet still another feature of the present invention is to provide a system to shorten sales cycles.

Still another feature of the present invention is utilizing a system to decrease the cost of a sale.

Yet another feature of the present invention is to provide a system to increase message frequency and reach.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, a system for tracking purchaser attributes is provided comprising the message manager, the attachment manager, the register manager, the direct mail manager, the content manager, the Microsite™ location, the content manager, the web master, the opportunity manager, the tracking manager, the user, the ESP database and, optionally, the website tracking manager.

In another embodiment, the present invention is a message manager. The message manager provides for implementing a message having the name of a prospect and a personalized message to that particular prospect within a message. The message manager provides for the following functions: maintenance, message library, edit message, create new message, subject library, edit subject, create new subject, logoff, executing a mail out, displays the user's name, select Microsite™ message for the recipients to visit, page name, preview, create subject or select subject from existing subjects, message library to select existing messages from drop down menu, create one time message or display selected message text, message replacement tags, link label, masks URL with “hot” text such as “click here,” customer search allows the user to select recipients by name, city, state, profile, or company name, select customers to send mail out to, check/uncheck all, include opt out message, submit sends message mail outs, and confirmation screen lists number of mail outs; successful and failed.

In another embodiment, the present invention provides an attachment manager for tracking the activity and success of an attachment by wrapping the attachment with a tracking link, enabling communication of exactly when the attachment is viewed as well as other characteristics. Further, the tracking technology automatically alerts the user both via email and the ESP opportunity manager of the exact time the attachment was viewed. The attachment manager provides the knowledge of who opened the attachments and when, sending batch attachments, ensuring virus-free delivery of attachments regardless of firewall or security settings, and personalize messaging with database driven prospect fields.

In yet another embodiment, the present invention provides a direct mail manager for tracking the direct mail results with the ESP tracking technology. The ESP generates a unique piece being sent and then tracks the personalized URL for each direct mail piece and associated URL, and its activity. Each unique visitor is tracked, and auto-populated into an ESP database. Each time a direct mail visitor enters the website or Microsite™ location through the unique link, the ESP technology alerts sales or marketing personnel of exactly who is visiting, when and for how long. The direct mail manager can be expressed as a method having the steps of the prospect receiving the mailed piece bearing a unique URL or custom link, engaging a web browser by the prospect, entering the unique URL or custom link by the prospect, entering the Microsite™ location, invoking a special message or page tied to the custom link, directing the prospect to a Microsite™ message, sending an entry alert to the user of the entry, creating a Microsite™ message, recording the prospects visit, upon completion of the visit by the prospect, sending a message to the user concerning same.

In another embodiment, the present invention provides a register manager comprising form information, maintenance, register mail out information, visit reply information and log off. The register manager provides a vehicle for a prospect to register or signup for something such as, for example, information, newsletter, etc., on a Website. A Microsite™ message is automatically pushed to the prospect. At the signup, a message is opened. The register manager captures the email addresses and provides the rapid response of information requested which is tracked. The register manager provides directives for processing form submittals which directives are established. The register manager enables a motivated prospect to advance automatically without the intervention of a salesman.

In yet another embodiment, the present invention provides a website tracking component comprising two aspects as the integration of ESP technology into existing websites and the engagement of existing website with ESP technology. The website tracking component sends a message or direct mail to the prospect with a link to the website. The prospect engages the link to the website. The prospect engages the website. And, the website communicates with the ESP database for recording, tracking and further engaging the prospect via the website.

In another embodiment, the present invention provides a simplified web traching system of the present invention comprises an already existing website that is to be monitored for interaction with a potential customer. The user engages the register manager or some other channel to push one or more forms to be placed on the website. When the customer completes the form, the information in the form is distributed to the tracking manager. The tracking manager has associated a register submit processor with rules. The register submit processor receives the form information and applies the rules. The rules are predetermined responses to the varying possibilities associated with the forms. The rules make a determination based upon the form information to push a Microsite™ message to a specific location, such as for example, a hidden location on the website, a customized location on the website or to a Microsite™ location. The customer is provided a Microsite™ message requesting the engagement of the specific location, such as for example, a hidden location on the website, a customized location on the website or to a Microsite™ location. The customer and the tracking manager, website and Microsite™ location continue to independently interact with the rules as the guide. As the interaction continues, the user can monitor everything, in detail, by engagement with the tracking manager. If an additional Microsite™ message is, in the judgment of the user, needed, then the user can engage the message manager to push the message needed to the location of choice such as, for example, the Microsite™ location.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a flow chart of preferred embodiments of the present invention.

FIG. 2 is a flow chart of a preferred embodiment of the system of the present invention.

FIG. 3 is a flow chart of a preferred embodiment of the message manager of the system associated with the present invention.

FIG. 4 is a flow chart of a preferred embodiment of the attachment manager of the system associated with the present invention.

FIG. 5 is a flow chart of a preferred embodiment of the direct mail manager of the system associated with the present invention.

FIG. 6 is a flow chart of a preferred embodiment of the opportunity manager of the system associated with the present invention.

FIG. 7 is a flow chart of a preferred embodiment of the register manager of the system associated with the present invention.

FIG. 8 is a flow chart of a preferred embodiment of the website tracking component of the system associated with the present invention.

FIG. 9 is a flow chart of a preferred embodiment of the tracking manager of the system associated with the present invention.

FIG. 10 is a flow chart of a preferred embodiment of the content manager of the system associated with the present invention.

FIG. 11 is a flow chart of a preferred embodiment of a simplified web tracking system associated with the present invention.

FIG. 12 is a flow chart of a preferred embodiment of the steps taken by a potential customer for engaging the simplified web tracking system of the present invention illustrated in FIG. 11.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

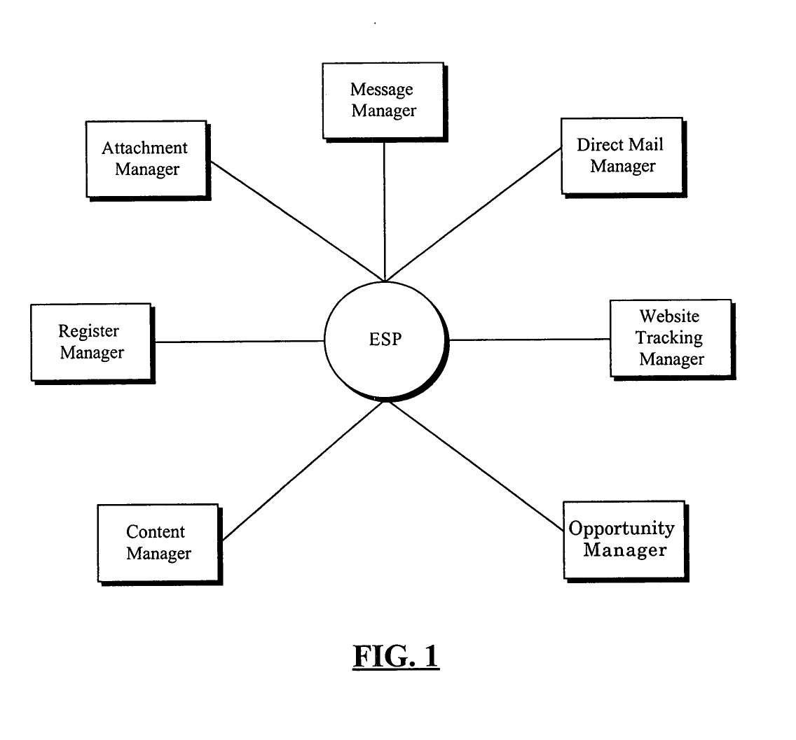

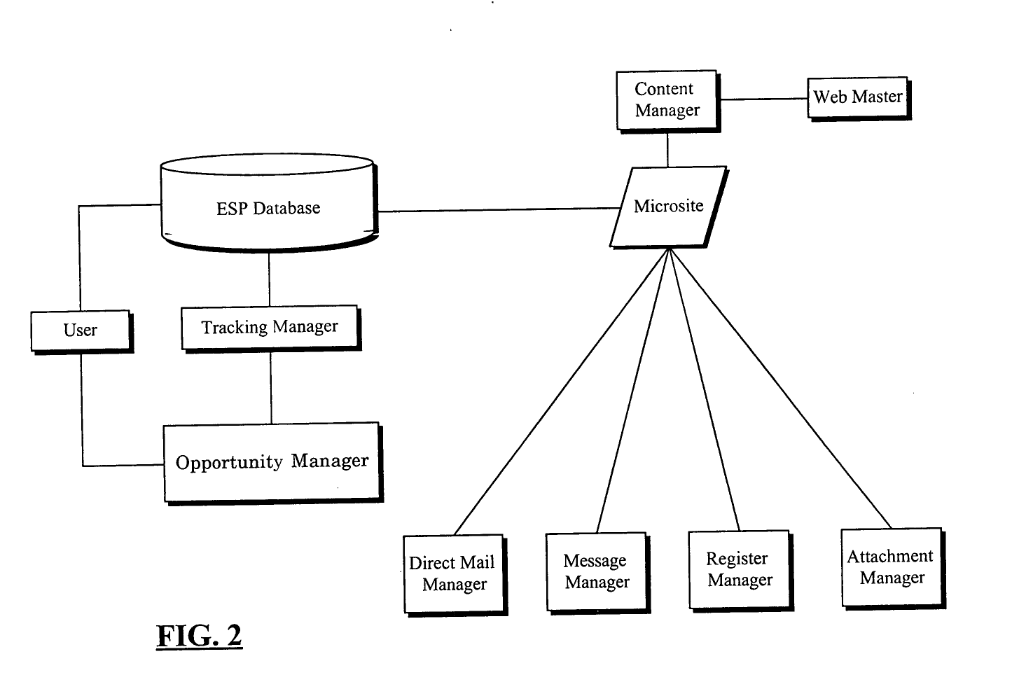

FIG. 1 is a flow chart of preferred embodiments of the present invention. FIG. 1 illustrates the message manager, the attachment manager, register manager, the direct mail manager, website tracking manager, the opportunity manager, and the content manager,

Generally, the message manager provides for sending batch email campaigns to prospects, personalized messaging with database driven prospect fields and tracking prospects' interests. The attachment manager provides for the ability to know who opened your attachments and when, sending batch attachments, ensuring delivery of attachments regardless at firewall or security settings, and personalized messaging with database driven prospect fields. The direct mail manager provides for tracking direct mail campaigns with unique URLs that drive the prospect back to a specific web location, instantly creates direct mail labels from prospect lists, and provides that the sender is instantly notified when a prospect has clicked back to the referenced site. The opportunity manager provides for tracking prospects' activity from email, direct mail or web campaigns, tracking sales activities, track marketing efforts, batch uploading existing prospect lists, and categorized prospects by profiles. The content manager provides for creating a library of marketing campaign messages, create sales tools, use of predefined templates or import desired templates, and personalizes messaging with database driven prospect fields. The website tracker provides for a website to become a trackable sales collateral, the universal code being placed on any web page/platform (e.g., Microsoft, Unix, etc.) to facilitate the capturing of user review data (e.g., when, how long, in what sequence), the seamless integration with ESP technology (ESP Managers/ESP Database), and any web page within the WWW can be tracked with the technology of the present invention.

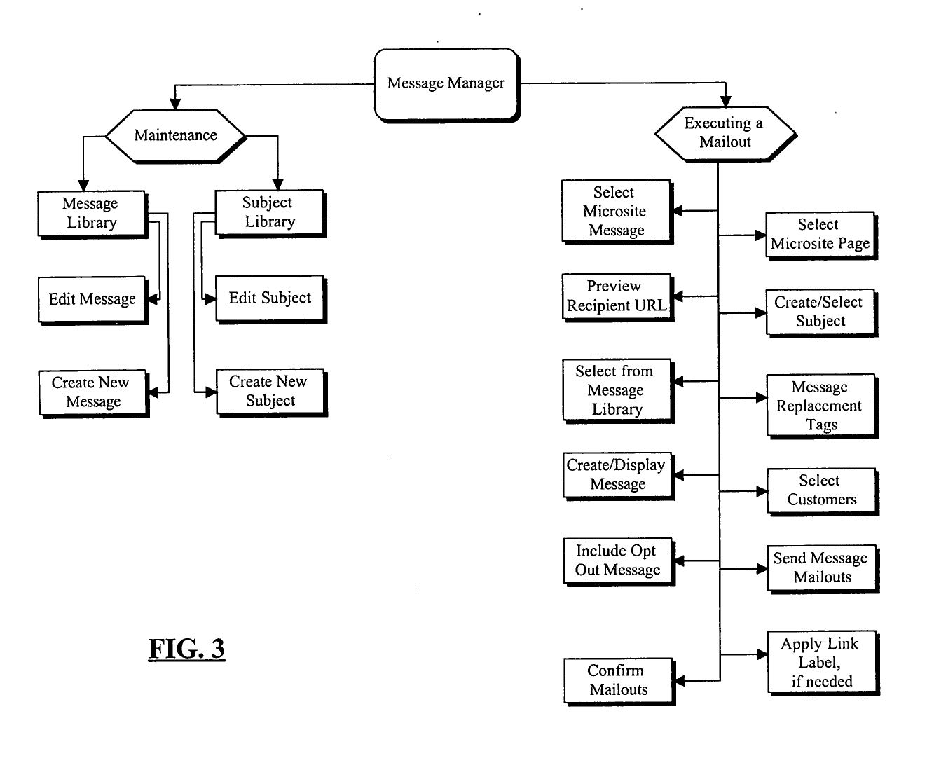

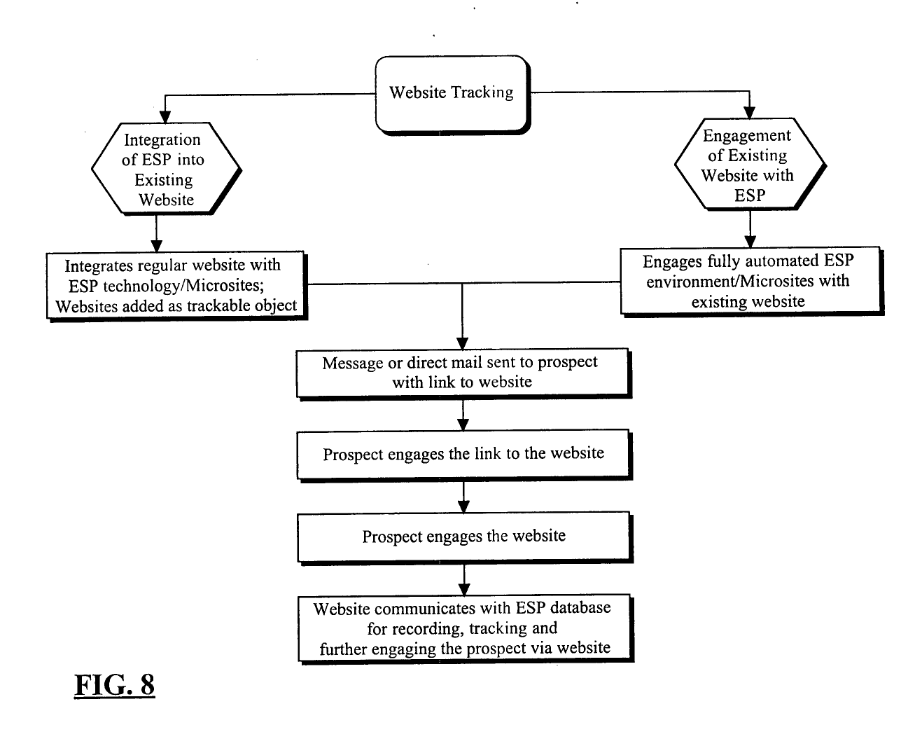

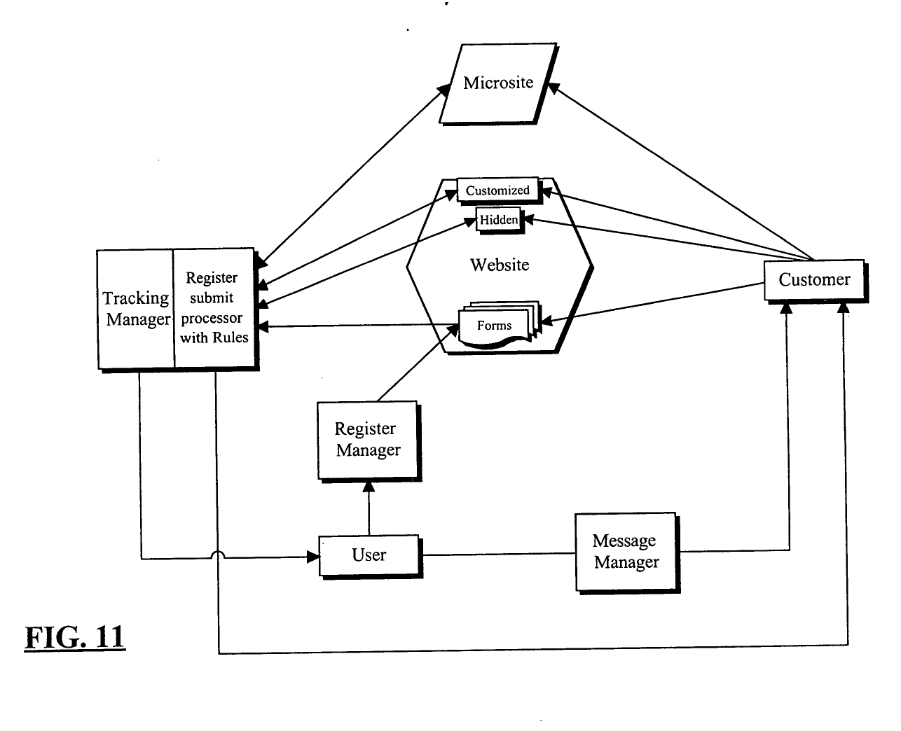

FIG. 2 is a flow chart of a preferred embodiment of the system for tracking purchaser attributes of the present invention. FIG. 2 illustrates the system for tracking purchaser attributes of the present invention comprising the message manager, the attachment manager, the register manager, the direct mail manager, the content manager, the Microsite™ location, the content manager, the web master, the opportunity manager, the tracking manager, the user, the ESP database and, optionally, the website tracking manager (not illustrated in FIG. 2; see FIGS. 8 and 11).

FIG. 3 is a flow chart of a preferred embodiment of the message manager of the system associated with the present invention. The message manager tracks a prospect's interest and online activity. The message manager is a tool that electronically sends out specialized emails that tracks a prospect's interests. The emails contain links back to a Microsite™ message or location. A Microsite™ message or location is a specialized tracking technology.

The message manager introduces the one-to-one relationship of electronic communication instead of the typical process of “spamming” individuals through mass emailing. Each Microsite™ message is personalized with the prospect's name and with a customized message catered to the prospect's needs and interests. When the Microsite™ messages are sent, the messages appears to the prospect as though the message was sent directly to them, and only them. The basic features of the the message manager are to send batch email campaigns to your prospects, track a prospect's interests, and personalize messaging with database driven prospect fields.

The Microsite™ message is a key component of the present invention. The Microsite™ message is a small collection of web pages. The Microsite™ message is not a subset of a website, but can be associated with a website. Typically, the Microsite™ message is independent of any website. However, The Microsite™ message is for a specific target audience, on a specific topic.

The message manager has the following functions or characteristics: maintenance, message library, edit message, create new message, subject library, edit subject, create new subject, logoff, executing a mail out, displays the user's name, select Microsite™ message for the recipients to visit, page name (select page of Microsite™ location you want recipient to be directed to first), preview (view what recipients will see when they click the URL), subject (create subject or select subject from existing subjects), message library (select existing message from drop down menu), message (create one time message or displays selected message text, message replacement tags, link label (masks URL with “hot” text such as “click here”), customer search (allows user to select recipients by name, city, state, profile, or company name), select customers to send mail out to, check/uncheck all, include opt out message, submit sends message mail outs, and confirmation screen lists number of mail outs; successful and failed.

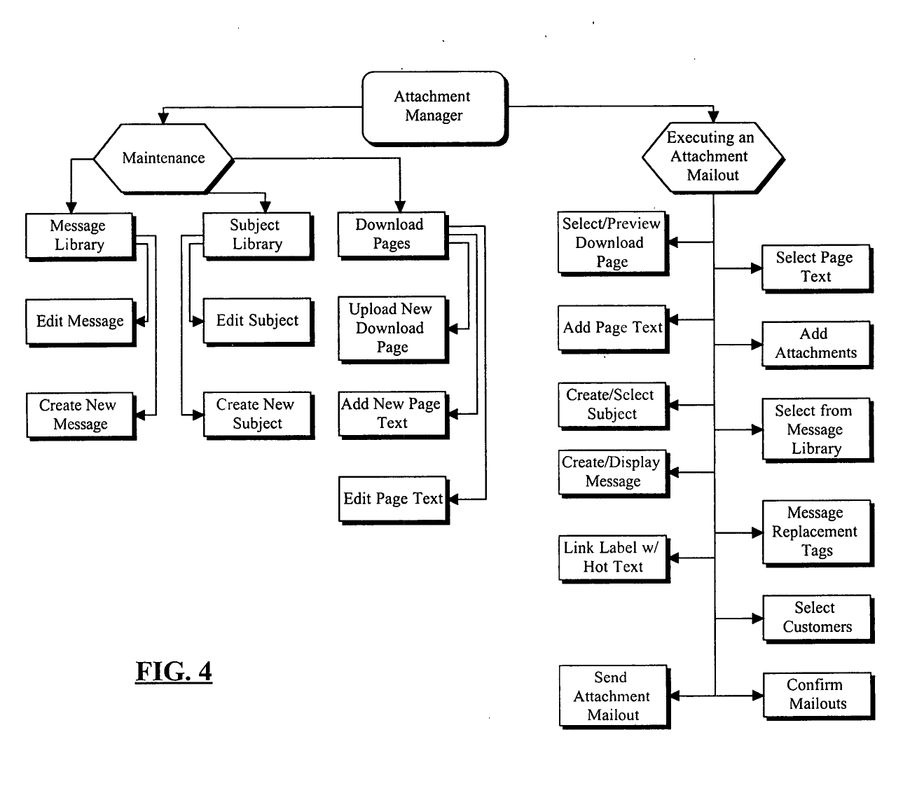

FIG. 4 is a flow chart of a preferred embodiment of the attachment manager of the system associated with the present invention. The attachment manager tracks the activity and success of attachments. It is known, especially by salespeople, that it is difficult to make a follow-up call without knowing if the prospect has read requested attachments. There has never been a factual way to know when an attachment is viewed.

The attachment manager uses the Microsite™ technology to wrap the attachment with a tracking link, enabling you to know exactly when the attachment is viewed. Further, the tracking technology automatically alerts the salesperson both via email and the ESP Productivity Manager of the exact time the attachment was viewed.

The key benefits of the attachment manager are the ability to know who opened the attachments and when, to send batch attachments, to ensure virus-free delivery of attachments regardless of firewall or security settings, and to personalize messaging with database driven prospect fields.

The attachment manager has the basic objectives of providing a facility to wrap the tracking technology of the present invention around different types of documents and deliver these documents. The attachment manager tracks if the message is opened. Also, the attachment manager tracks if a wrapper document was opened or the recipient downloaded the document. The attachment manager provides a facility to manage various wrapper templates and various wrapper documents such as, for example, pdf, doc, xls, ppt, etc. Further, the attachment manager creates a technology to dynamically publish or assemble the wrapper message at “click link time.”

The attachment manager adds tracking for a conventional process of emailing files as attachments to prospective customers. The attachment manager eliminates the fear of emails with attachments that may have viruses.

The attachment manager templates are prebuilt, ready to carry documents to prospective customers, and may be titled “From the Desk Of” to bring life and color to the old preprinted card. The attachment manager templates may have extra pages that are always pushed to prospects which enhance the brand of the company and the “sender” may include extra pages like company profile, a product fact sheet, press release pages, a chase study page and the like.

The attachment manager files can be sent ad hoc. The attachment manager files can be preregistered into a collateral library, provide for auto creation of the wrapper homepage, to select a wrapper template at “send” time, to select a wrapper template to a file to a prospective customer attribute, to send an email invitation and publish a wrapper message at the same time, to dynamically publish different wrapper messages that start with a blank canvass by pre-established directives saved in the ESP database or canvass objects picked up from ESP at send time.

The attachment manager has the following functions or characteristics: maintenance, download pages, upload new download page, add new page text, edit page text, message library, edit message, create new message, subject library, edit subject, create new subject, logoff, executing an attachment mail out, displays the user's name, select download page, page text (select page text from menu for the download page), add page text (name and create new text), preview (view what recipients will see when they click the URL), add attachments, select file folder, or add file folder, browse for file to upload, or select file from list, attach file, subject (create subject or select subject from existing subjects), message library (select existing message from drop down menu), message (create one time message or displays selected message text, message replacement tags, link label (masks URL with “hot” text such as “click here”), customer search (allows user to select recipients by name, city, state, profile, or company name), select customers to send mail out to, check/uncheck all, “submit” sends attachment mail out, and confirmation screen lists number of mail outs: successful and failed.

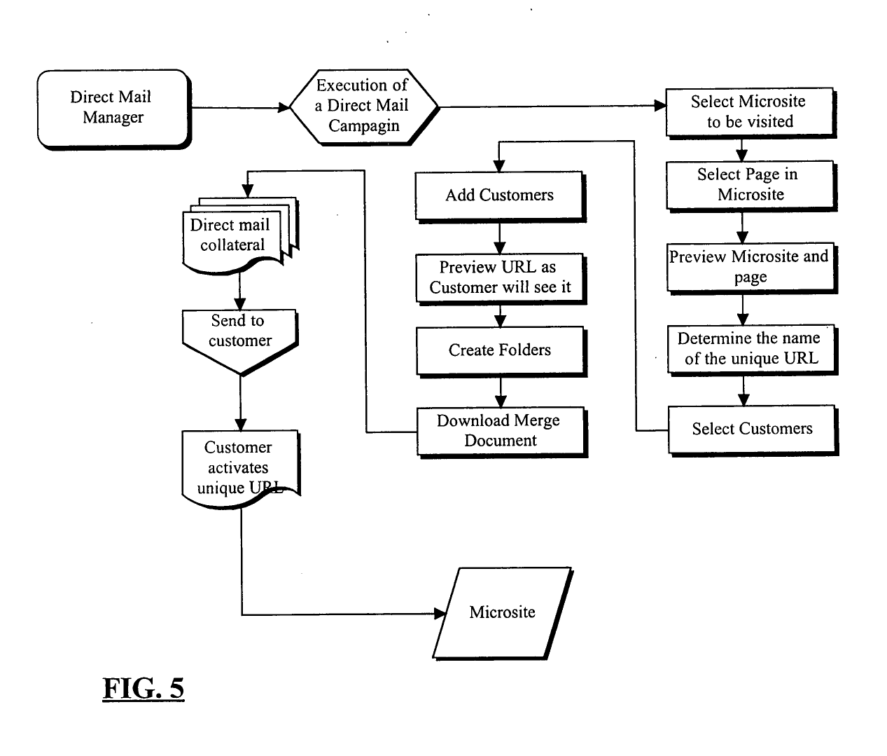

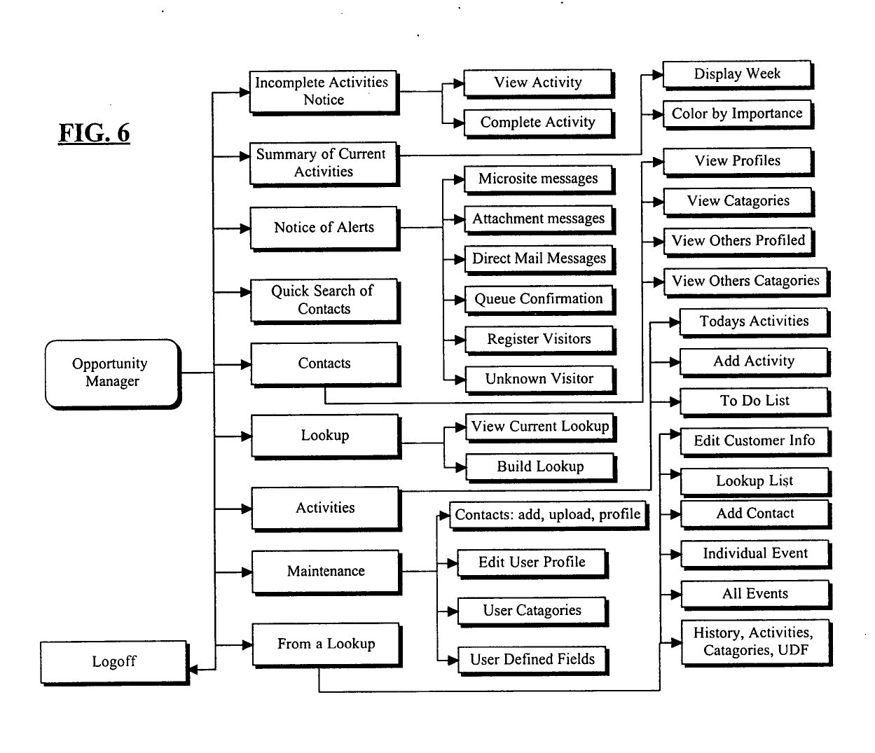

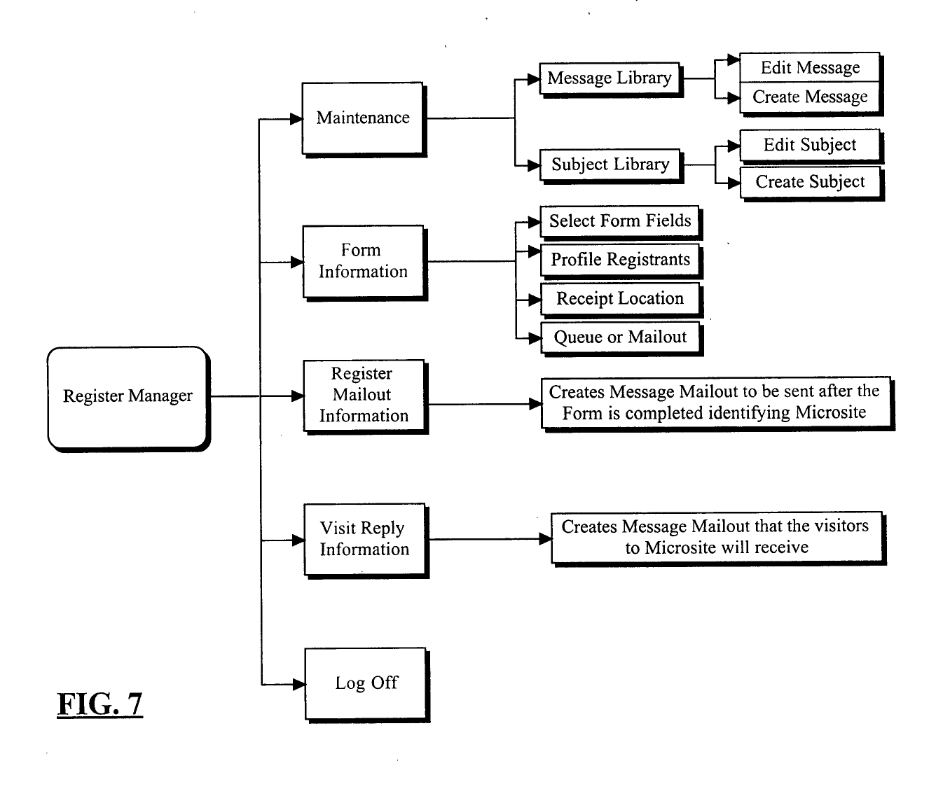

FIG. 5 is a flow chart of a preferred embodiment of the direct mail manager of the system associated with the present invention. The direct mail manager tracks any direct mail campaign. The direct mail manager is a reliable way to track paper mail outs. The direct mail manager tracks direct mail results with the ESP tracking technology. The direct mail manager is a tool that tracks direct mail campaign success. The ESP generates a unique piece being sent and then tracks the personalized URL for each direct mail piece and associated URL, and its activity. Each unique visitor is tracked, and auto-populated into an ESP database. Each time a direct mail visitor enters the website or Microsite™ location through the unique link, ESP technology alerts sales or marketing personnel exactly who is visiting, when and for how long. Furthermore, one can instantly create direct mail campaign labeling from any prospect list.

The key benefits of the direct mail manager are to track direct mail campaigns with unique URLs that focus the prospect back to the site, to instantly create direct mail labels from prospect lists, and to be instantly notified when a prospect has clicked back to the site.

The objectives of the direct mail manager are to bridge the gap between direct mail and email, to push Microsite™ messages via letters, post cards, etc., and to provide another delivery or tracking channel to the business development process. The direct mail manager uses conventional to deliver an invite to a Microsite™ message. The direct mail manager uses custom links for a specific potential customer or prospect. The custom link can be comprised of two parts: a generic part and a specific part. The generic part could be, for example, esp.w5.com and the specific part could be /garyhastings. The direct mail manager can use message replacement tags such as for example first name, last name, company name, salutation, etc. The message replacement tags are preferably resolved when the content is pushed to the browser's window, i.e., real time.

The direct mail manager has the steps of the prospect receiving the mailed piece bearing the unique URL or custom link, engaging a web browser, entering the unique URL or custom link, entering the Microsite™ location, invoking a special message or page tied to the custom link, directing the prospect to a Microsite™ message, sending an entry alert to the ESP user of the entry, creating a Microsite™ message, recording the prospects visit, upon completion of the visit by the prospect, sending a message to the ESP user concerning same.

FIG. 6 is a flow chart of a preferred embodiment of the opportunity manager of the system associated with the present invention. The opportunity manager of the system associated with the present invention provides for tracking a prospects' activity from email or direct mail campaign, tracking sales activities, tracking marketing efforts, batch uploading existing prospect lists, and categorizing prospects by profiles.

The opportunity manager coordinates prospect information and integrates the sales and marketing efforts. The opportunity manager integrates Direct Mail Manager, Message Manager and Attachment Manager into a new, single solution for sales and marketing. The opportunity manager is a powerful tool that enables one to maintain constant and timely interaction with prospects while tracking their activity.

Traditional CRM packages merely keep track of a salesperson's progress in the sales cycle. For example, a salesperson logs each point of contact: emailed client, left message or sales appointment. But with ESP Opportunity Manager, the ESP technology automatically logs each point of contact of the prospect or customer along with tracking the salesperson's activities. The opportunity manager tracks prospects activity from email or direct mail campaigns, tracks sales activities, tracks marketing campaigns, uploads existing prospect lists, and categorizes prospects by profiles.

The opportunity manager provides contact management functions to users of the present invention, and tightly integrates the tracking and the management of messages, such as, for example, the creation, delivery and response of trackable message manager pushes.

The opportunity manager provides “notices” to users for activity with respect to all channels such as, for example, message manager, attachment manager, direct mail manager, register manager, website tracking, etc. Further, the opportunity manager provides individual channel counts, i.e., how many times specific prospects engage a Microsite™ location, a registration form, a web page, etc. Also, the opportunity manager records channel activity such as message manager visits, registrations, visits, etc. into a database record for the respective prospect.

The opportunity manager provides quick process “lookups” per channel. A lookup is a temporary grouping for a user to process information. In the present specification, process is interpreted broadly and means, for example, to follow up with, record, determine the next step, etc. The next step may be something as simple as another message manager push. The opportunity manager captures all ESP and conventional contact management activity into an individual prospect history section of the prospect's record in the ESP database. Further, the opportunity manager provides a quick message manager push through any of the channels from the prospect record view. For example with a single click, the appropriate channel push logic is invoked.

FIG. 7 is a flow chart of a preferred embodiment of the register manager of the system associated with the present invention. The register manager of the system associated with the present invention provides for form information, maintenance, register mail out information, visit reply information and log off. The maintenance function provides a message library for editing and creating messages, and a subject library for creating and editing the subjects. The register mail out information creates message mail out to be sent after the form is completed identifying a Microsite™ location. The visit reply information creates message mail out that the visitors to the Microsite™ location will receive.

The register manager provides a vehicle for a prospect to register or signup for something such as, for example, information, newsletter, etc., on a Website. A Microsite™ message is automatically pushed to the prospect. At the signup, a message is opened. The register manager captures the email addresses and provides the rapid response of information requested which is tracked. The register manager provides directives for processing form submittals which directives are established. The register manager enables a motivated prospect to advance automatically without the intervention of a salesman.

The visit behavior is compared to pre-established rules and if there is a match; another Microsite™ message is pushed out automatically. Where the site, the subject and the delivery template were setup in advance of the prospects visit. The template could be from a family of templates. The benefit is that the process of sending out simple follow up emails is automated which saves time and also ensures that the prospect is still being engaged.

For the register manager, after the “Thanks for registering” Microsite™ message is pushed to the suspect and after a delta time has expired without a “visit,” a “follow up” email will be automatically sent to the prospect posing the general question—“Have you had a chance to review the information I sent?” By comparison for the attachment manager, an attachment Microsite™ message is pushed and everything else is the same.

FIG. 8 is a flow chart of a preferred embodiment of the website tracking component of the system associated with the present invention. The website tracking component of the present invention incorporates two aspects. The two aspects are the integration of ESP technology into existing websites and the engagement of existing website with ESP technology.

With respect to the integration of ESP technology into existing websites provides for the integration of the regular website with ESP technology and/or Microsite™ locations. The websites are added as trackable objects. The website tracking component sends a message or direct mail to the prospect with link to the website. The prospect engages the link to the website. The prospect engages the website. And, the website communicates with the ESP database for recording, tracking and further engaging the prospect via the website.

With respect to the engagement of existing website with ESP technology provides for fully engaging the automated ESP technology and related Microsite™ locations with an existing website. Thereafter, the websites are added as trackable objects. The website tracking component sends a message or direct mail to the prospect with link to the website. The prospect engages the link to the website. The prospect engages the website. And, the website communicates with the ESP database for recording, tracking and further engaging the prospect via the website.

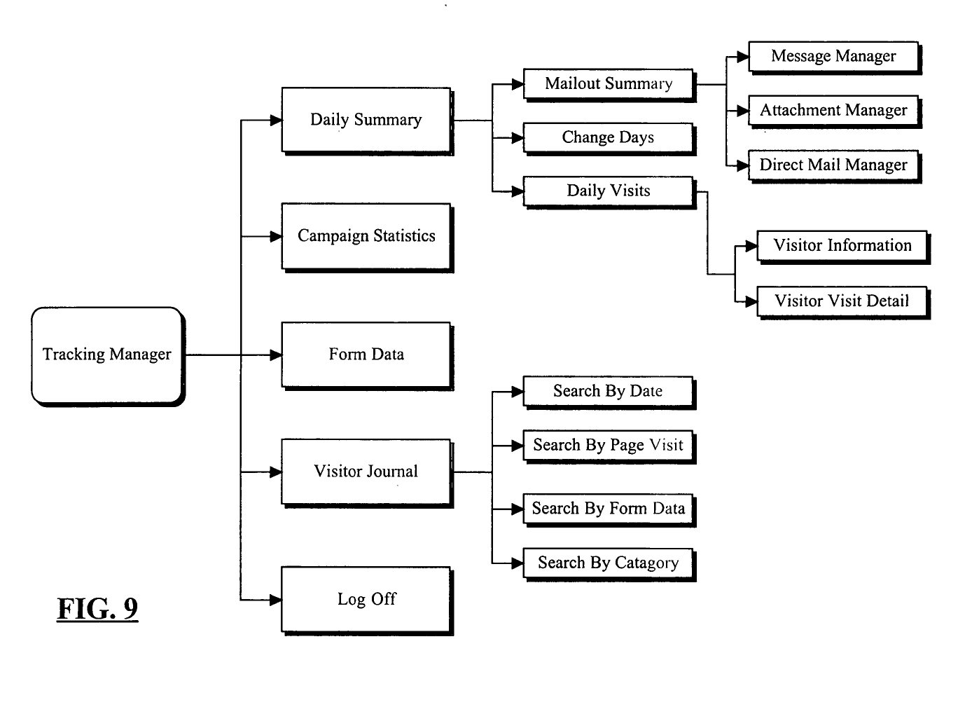

FIG. 9 is a flow chart of a preferred embodiment of the tracking manager of the system associated with the present invention. The tracking manager provides for a daily summary, campaign statistics, form data, visitor journal and logoff. The daily summary provides a mailout summary, change days and daily visits. The mailout summary is for coordination of the message manager, the attachment manager and the direct mail manager. The daily visits are adapted for visitor information and visitor visit detail. The visitor journal provides for a search by date, page visit, form data and category.

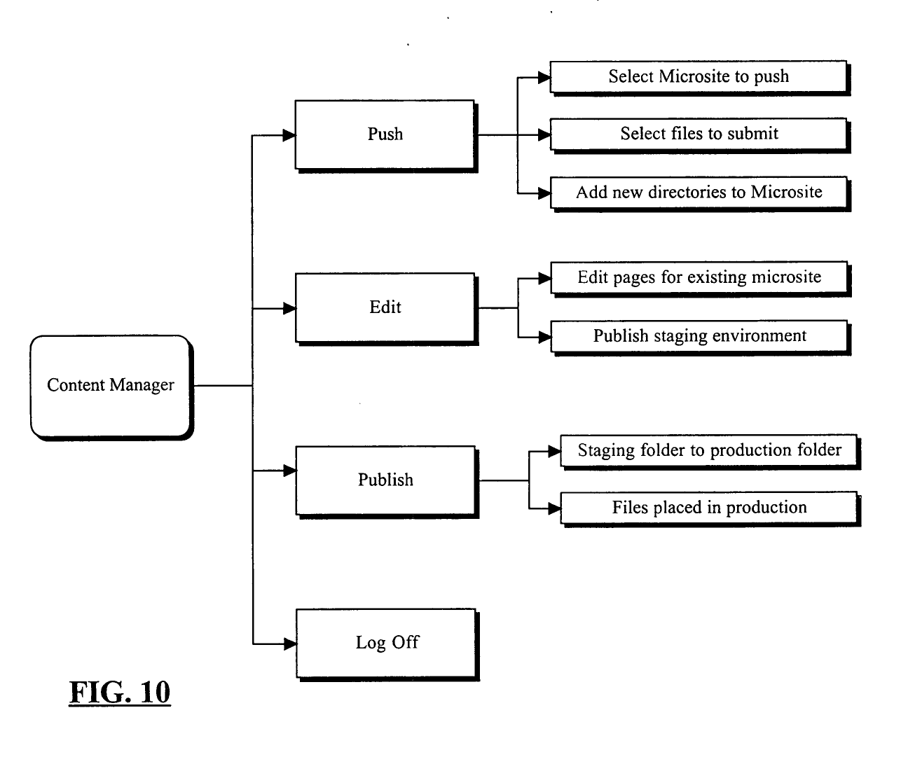

FIG. 10 is a flow chart of a preferred embodiment of the content manager associated with the present invention. The content manager provides for creating a library of marketing campaign messages, creating sales tools, using predefined templates or import desired templates, and personalizes messaging with database driven prospect fields.

The functions of the content manager are push, edit, publish and logoff. The push function is very important. The push function provides for selecting a Microsite™ message to propel, provoke or thrust the message to an appropriate location. Alternately, the push function provides for selecting selecting files to submit or adding new directories to a Microsite™ location.

The edit function provides for the editing of pages for an existing Microsite™ location or message and for the publishing of a staging environment. The publish function provides for the movement of the message from the staging folder to the production folder and for files to be placed in production.

FIG. 11 is a flow chart of a preferred embodiment of a simplified web tracking system associated with the present invention. The simplified web traching system of the present invention comprises an already existing website that is to be monitored for interaction with a potential customer. The user is to do the monitoring. The user engages the register manager or some other channel to push one or more forms to be placed on the website. When the customer completes the form, the information in the form is distributed to the tracking manager. The tracking manager has associated a register submit processor with rules. The register submit processor receives the form information and applies the rules. The rules are predetermined responses to the varying possibilities associated with the forms. The rules make a determination based upon the form information to push a Microsite™ message to a specific location, such as for example, a hidden location on the website, a customized location on the website or to a Microsite™ location. The customer is provided a Microsite™ message requesting the engagement of the specific location, such as for example, a hidden location on the website, a customized location on the website or to a Microsite™ location. The customer and the tracking manager, website and Microsite™ location continue to independently interact with the rules as the guide. As the interaction continues, the user can monitor everything, in detail, by engagement with the tracking manager. If an additional Microsite™ message is, in the judgment of the user, needed, then the user can engage the message manager to push the message needed to the location of choice such as, for example, the Microsite™ location.

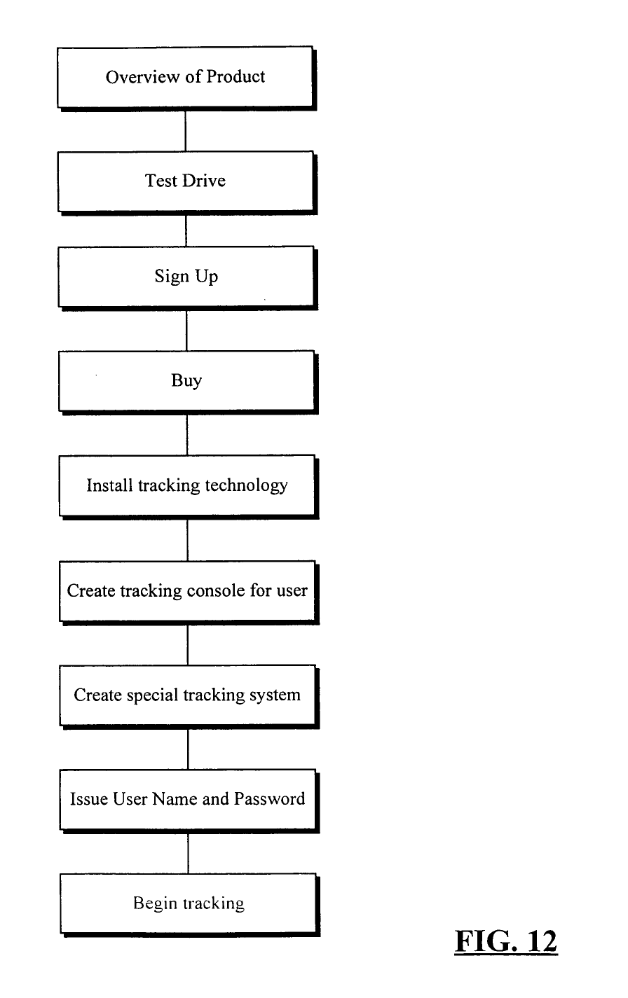

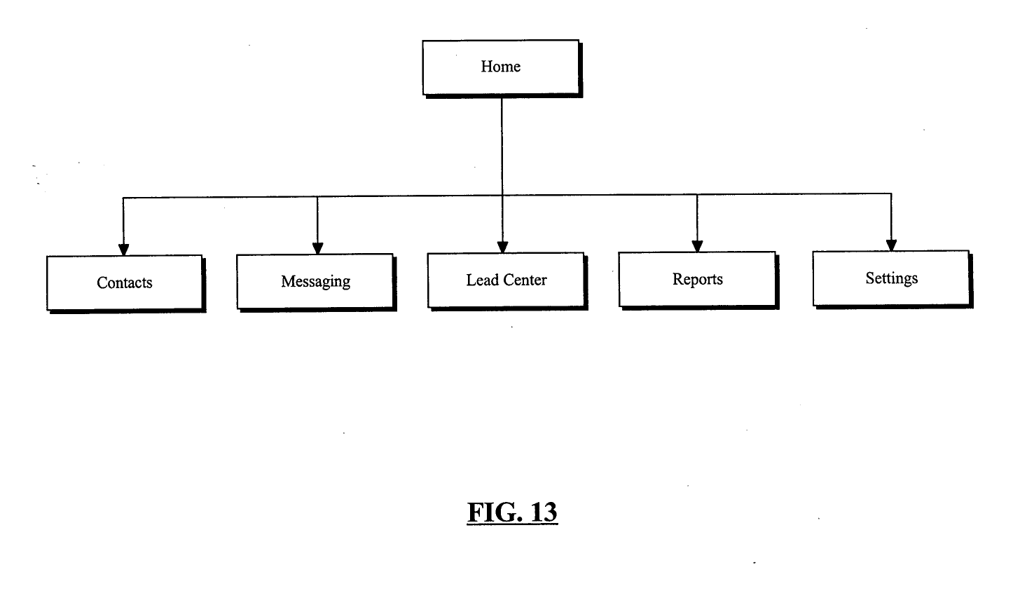

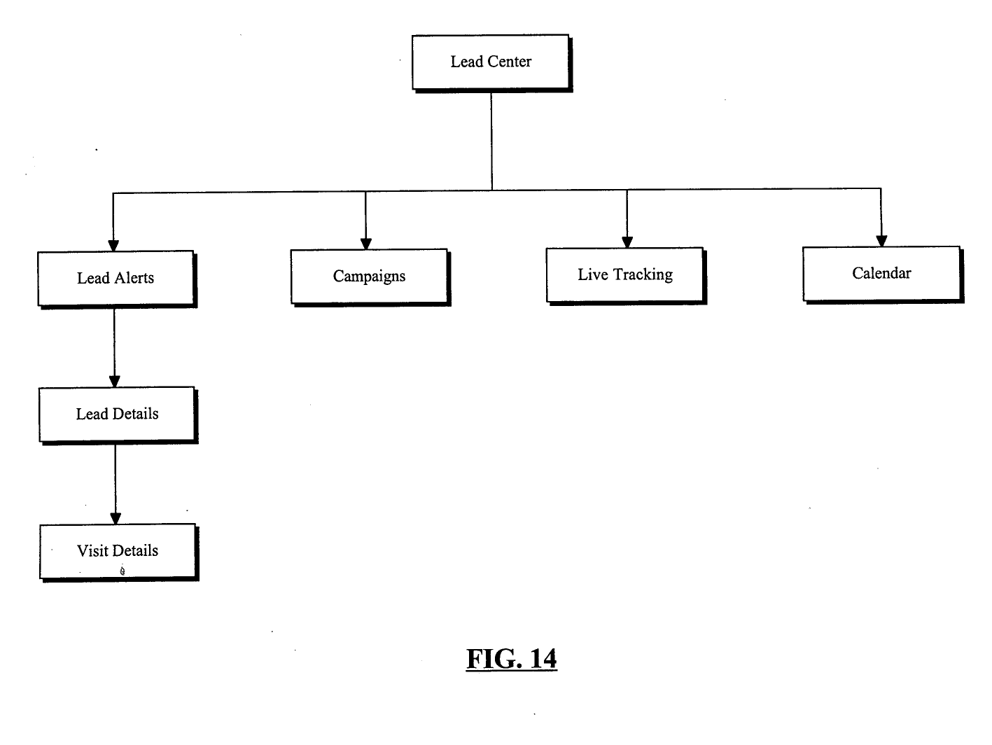

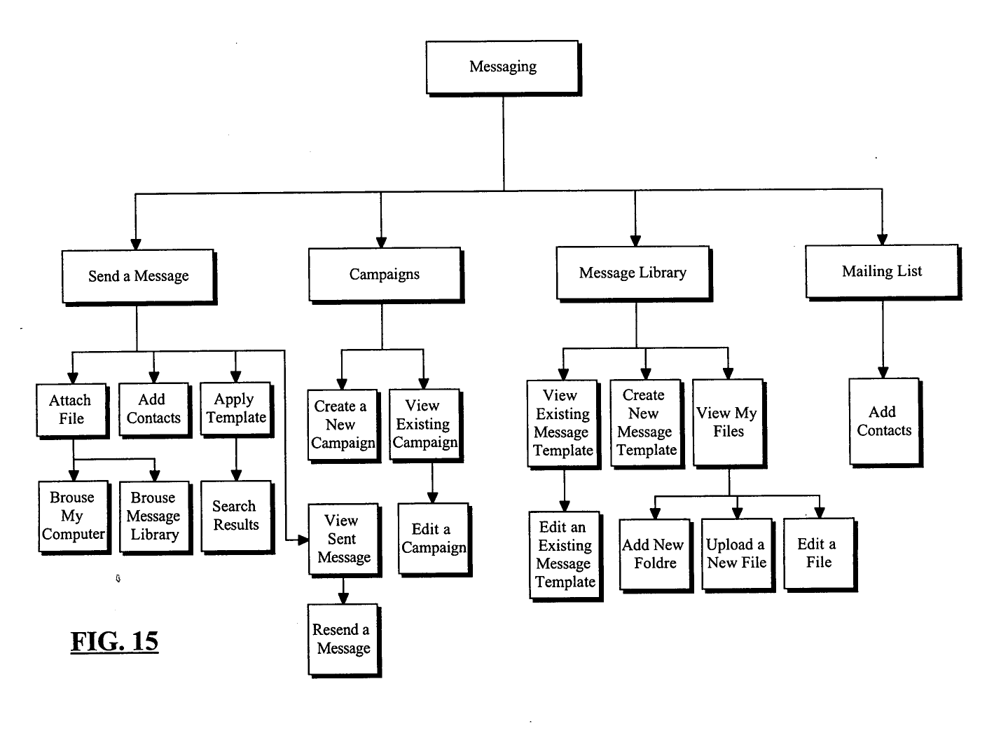

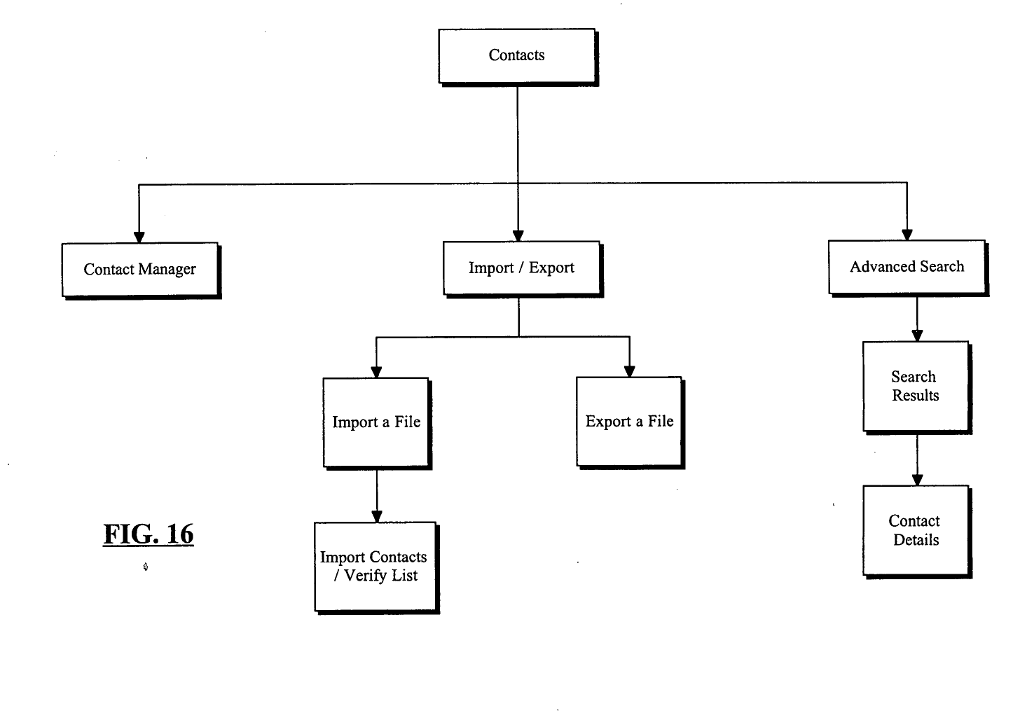

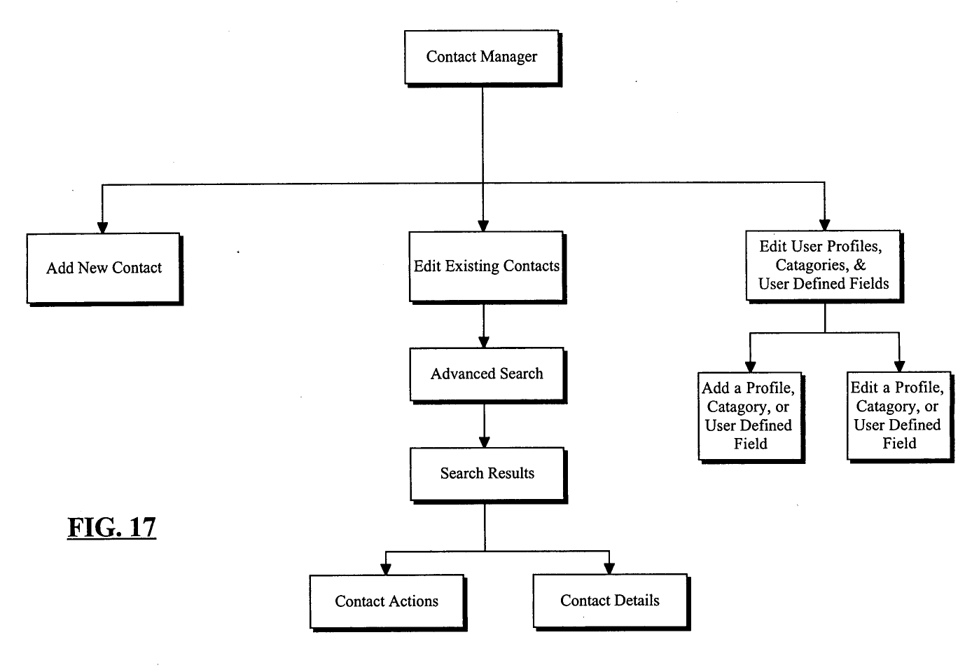

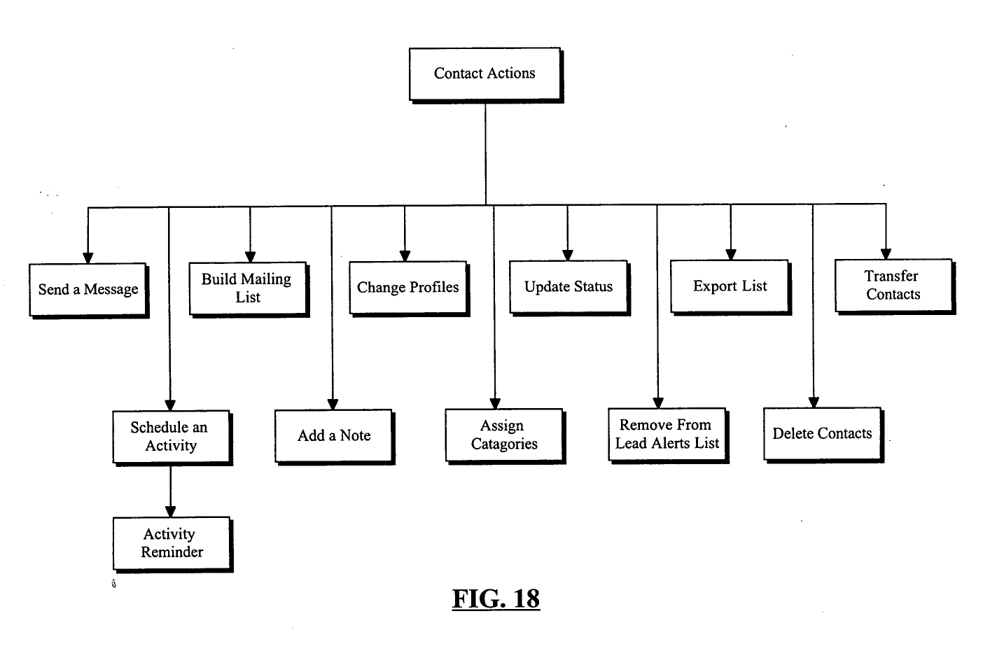

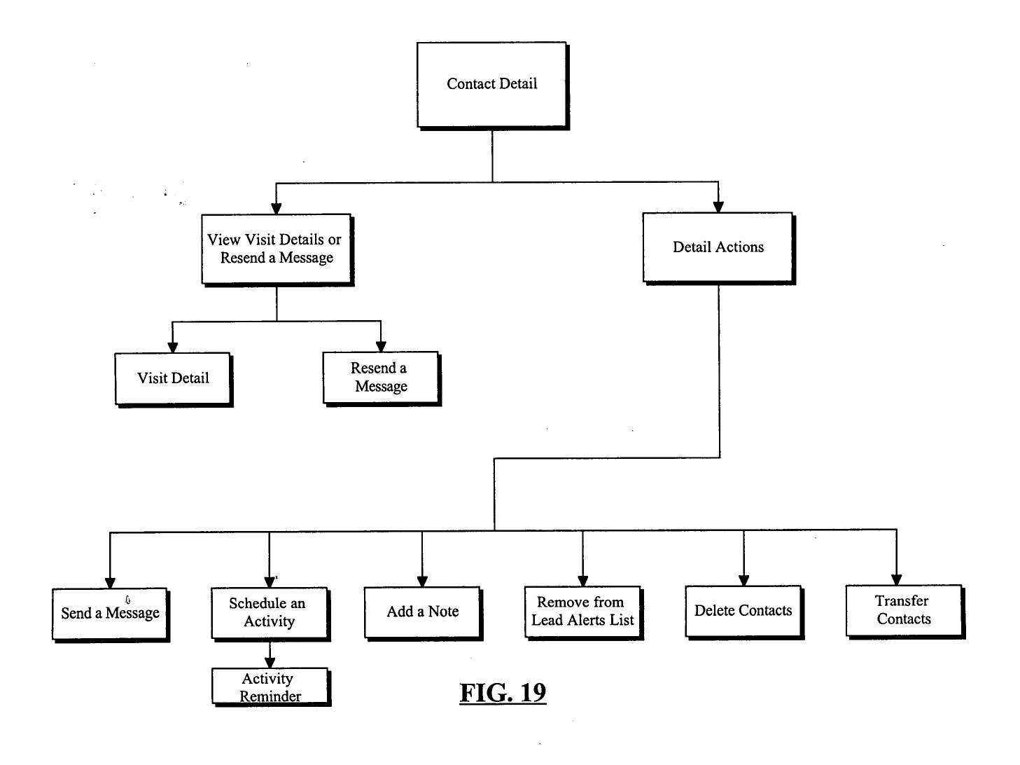

FIG. 12 is a flow chart of a preferred embodiment of the steps taken by a potential customer for engaging the simplified web tracking system of the present invention illustrated in FIG. 11. FIG. 11 illustrates the interaction of the various components of the simplified web tracking system of the present invention. FIG. 12 illustrates the steps taken by the customer to activate the simplified web tracking system. The steps are to receive the overview of the system, test drive the system, sign up for the system, buy the system, install the tracking technology, create a tracking console for the user, create special tracking system, issue a user name and password, and begin tracking.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

1. A message manager for tracking purchaser attributes comprising the steps of:
(a) delivering a message having the name of a prospect and a personalized message to that particular prospect within the message by a sender,
(b) maintaining the flow of messages,
(c) using a message library for creating messages,
(d) editing automatically the message,
(e) creating a new message, if needed,
(f) using an appropriate subject library, if needed,
(g) editing automatically a subject for the message, and
(h) creating new subject, if needed, such that a sender of the message manager can execute a mail out having one or more of, display the sender's name, select a Microsite™ message for the prospect to visit, select a page by name, preview the page, create subject for the mail out, select a subject from existing subjects for the mail out, use the message library to select existing messages, create a one time message, display selected message text, use message replacement tags, use a link label, mask the URL with “hot” text, conduct a customer search to select prospects by name, city, state, profile, or company name, select a prospect to send mail out to, check/uncheck all, include opt out message, send message mail outs, and confirm screen lists number of mail outs successful and failed such that an objective evaluation of the behavior of the prospect can be determined.

2. The message manager for tracking purchaser attributes and behavior as defined in claim 1 further comprising:
(a) a user interface accessible by a sender, the user interface for receiving criteria specified by the sender and for providing feedback with respect to the criteria whereby the feedback can go to at least one of the sender and a recipient,
(b) a database in communication with the user interface for receiving the criteria specified by the sender such that data that meets the criteria can be feedback to the sender via the user interface, and upon authorization by the sender to the recipient,
(c) a tracking interface in operative association with the database, and
(d) an input in communication with the tracking interface for providing select data from at least one of a suspect, a prospect, a customer and a client to the database such that the input is derived from one of the group comprising an email, a website, a registration form and an attachment such that the sender has real time access to the input in the database and, thus, can change the criteria instantaneously to initiate additional input based upon the changed criteria.

3. The message manager for tracking purchaser attributes and behavior as defined in claim 2 further comprising the sender having real time input concerning which prospect is providing the input, from where the prospect is providing the input, how long the prospect remained at the location, from where the input was submitted and what the prospect did to provide the input.

4. The message manager for tracking purchaser attributes and behavior as defined in claim 2 further comprising the sender having real time input concerning at least one of who is providing the input, where the provider of the input is located, how long the provider of the input remains at each location and what the provider of the input did at each location such that an objective evaluation of the behavior of the prospect can be determined.

5. The message manager for tracking purchaser attributes and behavior as defined in claim 2 further comprising an automated lead distribution report provided to the sender based upon the criteria comprising aggregated data from the database without the requirement for the sender to access the aggregated data such that the aggregated data comprises at least one of who is providing the input, where the provider of the input is located, how long the provider of the input remains at each location and what the provider of the input did at each location.

6. The message manager for tracking purchaser attributes and behavior as defined in claim 2 further comprising lead distribution rules for controlling how the input is distributed.

7. The message manager for tracking purchaser attributes and behavior as defined in claim 2 further comprising lead processing rules for controlling how input is acquired.

8. The message manager for tracking purchaser attributes and behavior as defined in claim 2 wherein the input comprises at least one of a registration lead alert, a return visitor lead alert and a link response lead alert based upon a prior sent email.

9. The message manager for tracking purchaser attributes and behavior as defined in claim 2 further comprising lead category engine for determining the attributes of the input in the form of leads.

10. The message manager for tracking purchaser attributes and behavior as defined in claim 2 further comprising a lead distribution engine for determining which senders and recipients receive the data from the database based upon specific criteria.

11. The message manager for tracking purchaser attributes and behavior as defined in claim 2 further comprising a campaign scheduling mode for delivering in an unattended manor a predetermined message based upon a predetermined campaign strategy to a predetermined target set of prospects over a specified period of time based upon specific review behavior criteria such that an objective evaluation of the behavior of the predetermined target set of prospects can be determined such that the campaign scheduling is based upon the behavior of the just completed behavior of the prospect.

12. The message manager for tracking purchaser attributes and behavior as defined in claim 11 wherein the campaign scheduling mode uses prospect data reflecting tangible review behavior of at least one of which prospect is providing the input, from where did the input originate, how long did the prospect remain at where the input originated and what the prospect did at each location such that an objective evaluation of the behavior of the prospect can be determined.

13. The message manager for tracking purchaser attributes and behavior as defined in claim 12 further comprising making a first objective evaluation of the behavior of the prospect, and based upon the data from the first objective evaluation, making a second objective evaluation of the prospect, and based upon the data from the second objective evaluation, making a third objective evaluation of the prospect, and continuing until an evaluation of the prospect is sufficiently complete such that an objective evaluation of the behavior of the prospect can be determined.

14. The message manager for tracking purchaser attributes and behavior as defined in claim 13 further comprising implementing different campaign strategies based upon the repetitive objective evaluations of the behavior of the prospect.

15. The message manager for tracking purchaser attributes and behavior as defined in claim 11 wherein the specified period of time is at a specific time.

16. The message manager for tracking purchaser attributes and behavior as defined in claim 11 wherein the specified period of time is for a specific interval of time.

17. The message manager for tracking purchaser attributes and behavior as defined in claim 2 wherein the replacement tags comprise contact tags to determine to whom the message is to be sent, signature tags to determine from whom the message is from, and web tags as message tags.

18. The message manager for tracking purchaser attributes and behavior as defined in claim 2 wherein to conduct a customer search comprises creating a target set of prospects from collections of prospects based upon specific attributes.
